(19) United States
(12) Patent Application Publication
(10) Pub. No.: US 2016/0183583 A1
(43) Pub. Date: Jun. 30, 2016

(54) SAUCE BLOCK AND SLICE FOR PREPARING A HAMBURGER AND CORRESPONDING HAMBURGER PREPARATION METHOD

(71) Applicant: SOREAL-ILOU, BRIE (FR)

(72) Inventors: THOMAS GUYOT, GOVEN (FR); ALAIN TANGUY, JANZE (FR); GILLES BOCABEILLE, RENNES (FR)

(21) Appl. No.: 14/965,507

(22) Filed: Dec. 10, 2015

(30) Foreign Application Priority Data
Dec. 10, 2014 (FR) 1462184

(51) Int. Cl. A23L 1/0532; A23L 1/0562

(52) U.S. Cl. CPC A23L 1/39; A23L 1/0047; A23V 2002/00

(57) ABSTRACT

A block of sauce is provided, which is intended to be sliced. The block of sauce includes 4 to 7% by mass of gelatin, 0.2 to 0.8% by mass of iota and/or kappa type carrageenans and 20 to 40% by mass of fat solid at 20° C.

### 1. CROSS-REFERENCE TO RELATED APPLICATIONS

This Application claims priority to and the benefit of French Patent Application FR 2014/062184, filed Dec. 10, 2014, the content of which is incorporated herein by reference in its entirety.

### 2. FIELD OF THE DISCLOSURE

The field of the disclosure is the agribusiness field.

More specifically, the disclosure relates to a sauce block intended to be sliced, a slice of sauce obtained from this block and a corresponding method of preparing a hamburger.

In particular, the disclosure finds an application in hamburger preparation. It also applies to the preparation of meat or fish dishes in sauce.

### 3. PRIOR ART

One essential ingredient giving flavor to a hamburger is the layer of sauce that covers the meat or fish patty of the burger. This layer of sauce is deposited onto the cooked patty when the hamburger is assembled, and condiments, such as pickle slices for example, are possibly added to the layer.

In fast food restaurant chains, certain sauces used for hamburger preparation are packaged in flexible bottles, commonly called “squeeze bottles,” that are pressed to make the sauce come out. Sauce guns are also used to garnish a hamburger with sauce.

However, it is observed that the operation consisting of applying the sauce to the patty substantially increases the hamburger assembly time.

In addition, it is difficult for a fast food chain employee to precisely measure the quantity of sauce and to distribute the sauce uniformly on the patty using a flexible bottle, without wasting time.

In addition, repeatedly pressing flexible bottles can eventually lead to the onset of tendinitis of the hand.

### 4. SUMMARY

The applicant has observed, in a surprising and unexpected manner, by researching a sauce that enables these objectives to be met, that by combining gelatin, carrageenans and semi-solid fats in specific and original proportions, it was possible to obtain a block of sauce that can be sliced easily, providing sauce slices that melt at least partially in a few dozen seconds, upon placing them on a meat, fish or veggie burger that has just been cooked, without any additional cooking operation being necessary.

For this purpose, an exemplary embodiment of the present disclosure provides a block of sauce intended to be sliced comprising 4 to 7% by mass of gelatin, 0.2 to 0.8% by mass of iota and/or kappa type carrageenans and 20 to 40% by mass of fat solid at 20° C.

Thus, in an original way, an embodiment proposes a sauce enabling hamburger assembly to be simplified.

In the context of the present disclosure, “sauce” is understood to refer to a culinary preparation intended for the preparation of a dish, or to accompany a dish, that includes fat in its composition.

Preferably, the weight ratio between said gelatin and said carrageenans is between 7 and 15.

Advantageously, said fat belongs to the group comprising at least:
cocoa butter;
palm oil;
coconut oil.

In a variation, the sauce block comprises 4 to 7% by mass of gelatin, 0.2 to 0.8% by mass of iota and/or kappa carrageenans and 20 to 40% by mass of textured canola oil, to produce a cheese sauce or a slice of melting cheese.

In a particular embodiment, a sauce block as described above comprises 0.05 to 7% by mass of modified starch.

This prevents the sauce from dripping too much when it melts.

In a particular embodiment, a sauce block as described above comprises morsels, such as bits of a condiment and/or a vegetable.

According to a particular aspect, a sauce block as described above comprises 0.05 to 3% by mass of an emulsifier, such as egg yolks, lecithin, casein or a fatty acid mono- or di-glycerides, for example.

The disclosure also relates to a slice of sauce obtained by slicing a sauce block as described above.

Advantageously, such a slice of sauce presents a thickness of between 1 and 8 millimeters, preferably between 3 and 8 millimeters.

The disclosure also relates to a method for preparing a hamburger that is particularly simple to implement.

According to the disclosure, such a method comprises the following steps:
obtaining a block of sauce comprising 4 to 7% by mass of gelatin, 0.2 to 0.8% by mass of iota and/or kappa type carrageenans and 20 to 40% by mass of fat solid at 20° C.;
slicing said sauce block so as to obtain a slice of sauce;
cooking a ground beef burger, a fish burger or a veggie burger;
assembling said hamburger comprising a step of depositing said sauce slice on said cooked burger, so that said sauce slice melts at least partially on said burger.

It should be noted that, advantageously, the sauce slice melts in contact with the burger in under one minute, and typically in 20 to 30 seconds, depending on the thickness and composition of the slice.

According to a preferential aspect of the disclosure, said burger is brought to a temperature of between 69 and 80° C. during the cooking step.

### 5. DETAILED DESCRIPTION OF ILLUSTRATIVE EMBODIMENTS

Other characteristics and advantages will appear more clearly upon reading the following description of an embodiment of the present disclosure, given by way of a simple, non-limiting illustrative example.

Below the ingredients in the composition of an example of a sauce block according to the present disclosure are given, to produce one kilogram:
70 g gelatin;
3 g of a mixture of iota and kappa carrageenans (Matgel MI 6, sold by the AGI company);
300 g cocoa butter;
20 g powdered egg yolks;
40 g modified starch;
136.9 g water;
70 g tomato concentrate;
20 g mustard;
50 g vinegar;
3 g citric acid;
15 g salt;
100 g granulated sugar;
2 g potassium sorbate;
0.1 g flavoring;
170 g sweet and sour pickle slices.

To prepare a sauce block from these ingredients, all of the aforementioned ingredients, except for the pickle slices, are mixed in a first step for 20 minutes in a paddle and blade mixer-heater, until the temperature of the mixture reaches 90° C.

In a second step, the pickle slices are incorporated into the mixture, and are gently dispersed in the mixture until they are uniformly distributed in the mixture.

In a third step, the mixture obtained is poured into a tubular mold.

After the mixture is cooled, a block of gelled sauce is obtained, in a substantially cylindrical shape.

This solidified sauce block is then sliced in a slicer to obtain sauce slices with a thickness equal to approximately 4 millimeters.

It should be noted that the composition of the sauce block makes it firm and inelastic, which enables regular slices of an appropriate thickness to be obtained, and that the pickle slices do not break away during or after the slicing operation. On the other hand, in this particular embodiment, the composition of the gelled sauce slice was adapted so that it melts when it is brought above 38° C.

These slices can then be used directly in the hamburger preparation.

When the hamburger is assembled, the topping (a slice of lettuce and a slice of tomato), a slice of cheese and a cooked ground beef patty brought to a temperature of 72° C. are successively layered on a piece of bread, also called a “bun,” in an order that is known in itself. To finish the hamburger, the slice of sauce previously obtained is deposited on the patty and the slice of sauce is covered with a second piece of bread.

Approximately 30 seconds after the hamburger is assembled, the hamburger, whose sauce has melted and has distributed uniformly on the patty, can be consumed.

An exemplary embodiment of the present disclosure mitigates the disadvantages from the prior art cited above.

More specifically, an exemplary embodiment provides a sauce in solid or semi-solid form at room temperature, which can be easily cut into slices.

An exemplary embodiment provides a slice of sauce that melts in contact with a patty that has just been cooked.

An exemplary embodiment provides a sauce that is simple to implement.

An exemplary embodiment proposes a sauce that has a reduced cost.

An exemplary embodiment provides a sauce that is acceptable to consumers.

Although the present disclosure has been described with reference to one or more examples, workers skilled in the art will recognize that changes may be made in form and detail without departing from the scope of the disclosure and/or the appended claims.

1. A block of sauce intended to be sliced, wherein the block comprises:
4 to 7% by mass of gelatin,
0.2 to 0.8% by mass of iota and/or kappa type carrageenans, and
20 to 40% by mass of fat solid at 20° C.

2. The sauce block according to claim 1, wherein the weight ratio between said gelatin and said carrageenans is between 7 and 15.

3. The sauce block according to claim 1, wherein said fat belongs to the group comprising at least:
cocoa butter;
palm oil;
coconut oil.

4. The sauce block according to claim 1, wherein the block comprises 0.05 to 7% by mass of modified starch.

5. The sauce block according to claim 1, wherein the block comprises morsels.

6. The sauce block according to claim 1, wherein the block comprises 0.05 to 3% by mass of an emulsifier.

7. A slice of sauce obtained by slicing a sauce block according to claim 1.

8. The slice of sauce according to claim 7, wherein the slice presents a thickness of between 1 and 8 millimeters.

9. A method of preparing a hamburger, wherein the method comprises the following steps:
obtaining a block of sauce comprising 4 to 7% by mass of gelatin, 0.2 to 0.8% by mass of iota and/or kappa type carrageenans and 20 to 40% by mass of fat solid at 20° C.;
slicing said sauce block so as to obtain a slice of sauce;
cooking a ground beef burger, a fish burger or a veggie burger;
assembling said hamburger comprising a step of depositing said sauce slice on said cooked burger, so that said sauce slice melts at least partially on said burger.

10. The method of preparing a hamburger according to claim 9, wherein said burger is brought to a temperature of between 69 and 80° C. during said cooking step.

11. The method according to claim 5, wherein the morsels comprise bits of a condiment and/or a vegetable.

12. The method according to claim 6, wherein the emulsifier comprises egg yolks, lecithin, casein or fatty acid mono- or di-glycerides.

13. The slice of sauce according to claim 8, wherein the thickness is between 3 and 8 millimeters.
